(19) United States
(12) Patent Application Publication
(10) Pub. No.: US 2011/0249865 A1
(43) Pub. Date: Oct. 13, 2011

(54) APPARATUS, METHOD AND COMPUTER-READABLE MEDIUM PROVIDING MARKER-LESS MOTION CAPTURE OF HUMAN

(75) Inventors: Seung Sin LEE, Suji-gu (KR); Young Ran HAN, Suwon-si (KR); Michael NIKONOV, Moscow (RU); Pavel SOROKIN, Moscow (RU); Du-Sik PARK, Suwon-si (KR)

(73) Assignee: Samsung Electronics Co., Ltd., Suwon-si (KR)

(21) Appl. No.: 13/082,264

(22) Filed: Apr. 7, 2011

(30) Foreign Application Priority Data
Apr. 8, 2010 (RU) 2010113890

(51) Int. Cl. G06K 9/00

(52) U.S. Cl. 382/103

(57) ABSTRACT

Provided are an apparatus, method and computer-readable medium providing marker-less motion capture of a human. The apparatus may include a two-dimensional (2D) body part detection unit to detect, from input images, candidate 2D body part locations of candidate 2D body parts; a three-dimensional (3D) lower body part computation unit to compute 3D lower body parts using the detected candidate 2D body part locations; a 3D upper body computation unit to compute 3D upper body parts based on a body model; and a model rendering unit to render the model in accordance with a result of the computed 3D upper body parts.

### CROSS-REFERENCE TO RELATED APPLICATIONS

This application claims the benefit of Russian Patent Application No. 2010113890, filed on Apr. 8, 2010, in the Russian Intellectual Property Office, the disclosure of which is incorporated herein by reference.

### BACKGROUND

1. Field

Exemplary embodiments relate to an apparatus, method and computer-readable medium tracking marker-less motions of a subject in a three-dimensional (3D) environment.

2. Description of the Related Art

A three-dimensional (3D) modeling-based tracking method may detect a two-dimensional (2D) pose using a 2D body part detector, and perform 3D modeling using the detected 2D pose, thereby tracking 3D human motions.

In a method of capturing 3D human motions in which a marker is attached to a human to be tracked and a movement of the marker is tracked, a higher accuracy may be achieved, however, real-time processing of the motions may be difficult due to computational complexity.

Also, in a method of capturing the 3D human motions in which a human skeleton is configured using location information for each body part of a human, a computational speed may be increased due to a relatively small movement variable However, accuracy may be reduced.

### SUMMARY

The foregoing and/or other aspects are achieved by providing an apparatus capturing motions of a human, the apparatus including: a two-dimensional (2D) body part detection unit to detect, from input images, candidate 2D body part locations of candidate 2D body parts, a three-dimensional (3D) lower body part computation unit to compute 3D lower body parts using the detected candidate 2D body part locations, a 3D upper body computation unit to compute 3D upper body parts based on a body model, and a model rendering unit to render the model in accordance with a result of the computed 3D upper body parts, wherein, a model-rendered result is provided to the 2D body part detection unit, the 3D lower body parts are parts where a movement range is greater than a reference amount, from among the candidate 2D body parts, and the 3D upper body parts are parts where the movement range is less than the reference amount, from among the candidate 2D body parts.

In this instance, the 2D body part detection unit may include a 2D body part pruning unit to prune the candidate 2D body part locations that are a specified distance from predicted elbow/knee locations, from among the detected candidate 2D body part locations.

Also, the 3D lower body part computation unit may compute candidate 3D upper body part locations using upper body part locations of the pruned candidate 2D body part locations, the 3D upper body part computation unit may compute a 3D body pose using the computed candidate 3D upper body part locations based on the model, and the model rendering unit may provide a predicted 3D body pose to the 2D body part pruning unit, the predicted 3D body pose obtained by rendering the body model using the computed 3D body pose.

Also, the apparatus may further include: a depth extraction unit to extract a depth map from the input images, wherein the 3D lower body part computation unit computes candidate 3D lower body part locations using upper body part locations of the pruned candidate 2D body part locations and the depth map.

Also, the 2D body part detection unit may detect, from the input images, the candidate 2D body part locations for a Region of Interest (ROI), and include a graphic processing unit to divide the ROI of the input images into a plurality of channels to perform parallel image processing on the divided ROI.

The foregoing and/or other aspects are achieved by providing a method of capturing motions of a human, the method including: detecting, by a processor, candidate 2D body part locations of candidate 2D body parts from input images, computing, by the processor, 3D lower body parts using the detected candidate 2D body part locations, computing, by the processor, 3D upper body parts based on a body model, and rendering, by the processor, the body model in accordance with a result of the computed 3D upper body parts, wherein a model-rendered result is provided to the detecting, the 3D lower body parts are parts where a movement range is greater than a reference amount, from among the candidate 2D body parts, and the 3D upper body parts are parts where the movement range is less than the reference amount, from among the candidate 2D body parts.

In this instance, the detecting of the candidate 2D body part may include pruning the candidate 2D body part locations that are a specified distance from predicted elbow/knee locations, from among the detected candidate 2D body part locations.

Also, the computing of the 3D lower body parts includes computing candidate 3D lower body part locations using the pruned candidate 2D body part locations, the computing of the 3D upper body parts includes computing by the 3D upper body part computation unit, a 3D body pose using the computed candidate 3D upper body part locations based on the body model, and the rendering of the body model may provide a predicted 3D body pose to the processor, the predicted 3D body pose obtained by rendering the body model using the computed 3D body pose.

Also, the method may further include extracting a depth map from the input images, wherein the computing of the 3D lower body parts includes computing candidate 3D lower body part locations using the pruned candidate 2D body part locations and the depth map.

Also, the detecting of the 2D body part locations may detect, from the input images, the candidate 2D body part locations for an ROI, and include performing a parallel image processing on the ROI of the input images by dividing the ROI into a plurality of channels.

According to another aspect of one or more embodiments, there is provided at least one computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a diagram illustrating an example of a body part model;

FIG. 2 is a diagram illustrating another example of a body part model;

FIG. 3 is a flowchart illustrating a method of capturing motions of a human according to example embodiments;

FIG. 4 is a diagram illustrating a configuration of an apparatus capturing motions of a human according to example embodiments;

FIG. 5 is a diagram illustrating, in detail, a configuration of an apparatus capturing motions of a human according to example embodiments;

FIG. 6 is a flowchart illustrating, in detail, an example of a method of capturing motions of a human according to example embodiments;

FIG. 7 is a flowchart illustrating an example of a rendering process according to example embodiments;

FIG. 8 is a diagram illustrating an example of a triangular measurement method for 3D body parts which may divide three-dimensional (3D) body parts into a triangle according to example embodiments;

FIG. 9 is a diagram illustrating a configuration of an apparatus capturing motions of a human according to example embodiments;

FIG. 10 is a flowchart illustrating a method of capturing motions of a human according to example embodiments;

FIG. 11 is a diagram illustrating a region of interest (ROI) for input images according to example embodiments; and

FIG. 12 is a diagram illustrating an example of a parallel image processing according to example embodiments.

### DETAILED DESCRIPTION

Reference will now be made in detail to exemplary embodiments, examples of which are illustrated in the accompanying drawings, wherein like reference numerals refer to like elements throughout. Exemplary embodiments are described below to explain the present disclosure by referring to the figures.

According to example embodiments, a triangulated three-dimensional (3D) mesh model for a torso and upper arms/legs may be used and a rectangle-based two-dimensional (2D) part detector for lower arms/hands and lower legs may be used.

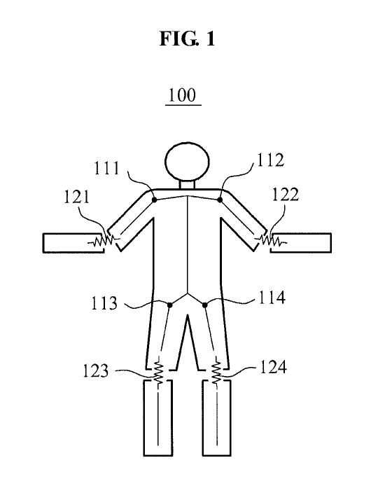

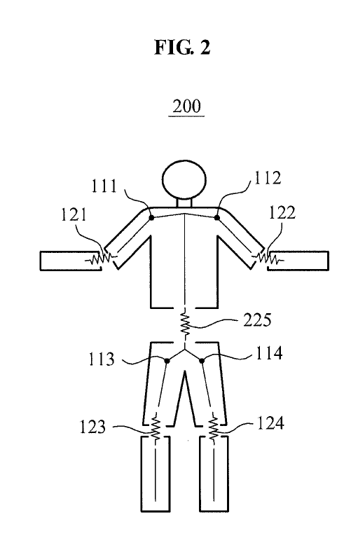

According example embodiments, the lower arms/hands and the lower legs are not rigidly connected to parent body parts. A soft connection is used instead. The concept of soft joint constraints as illustrated in FIGS. 1 and 2 is used.

Also, according to example embodiments, an algorithm for finding a 3D skeletal pose is used for each frame of input video sequence. At a minimum, a 3D skeleton includes a torso, upper/lower arms, and upper/lower legs. The 3D skeleton may also include additional body parts such as a head, hands, etc.

FIG. 1 is a diagram illustrating an example of a body part model 100.

Referring to FIG. 1, a first body part model 100 is divided into upper parts and lower parts based on ball joints 111, 112, 113, and 114 and soft joint constraints 121, 122, 123, and 124. The upper parts may be disposed between the ball joints 111, 112, 113, and 114 and the soft joint constraints 121, 122, 123, and 124, and may be body parts where a movement range is less than a reference amount. The lower part may be disposed between the soft joint constraints 121, 122, 123, and 124 and hands/feet, and may be parts where a movement range is greater than the reference amount.

FIG. 2 is a diagram illustrating another example of a body part model 200.

As illustrated in FIG. 2, a second body part model 200 further includes a soft joint constraint 225, and also is divided into upper parts and lower parts.

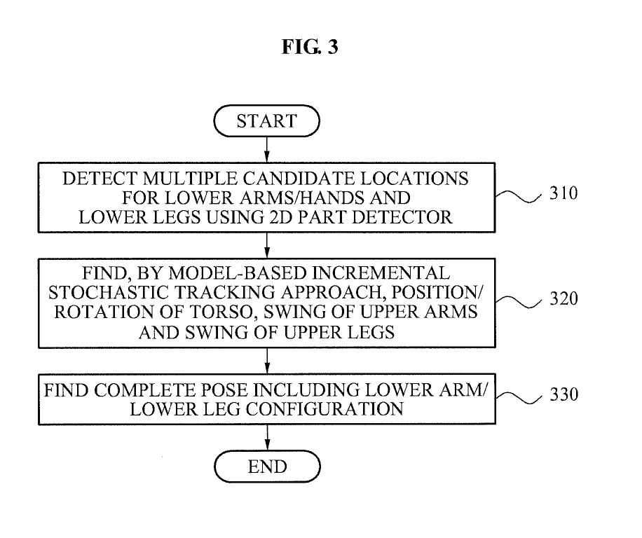

FIG. 3 is a flowchart illustrating a method of capturing motions of a human according to example embodiments.

Referring to FIG. 3, in operation 310, an apparatus capturing motions of a human detects multiple candidate locations for lower arms/hands and lower legs using a 2D part detector.

In operation 320, the apparatus uses a model-based incremental stochastic tracking approach used to find position/rotation of a torso, swing of upper arms, and swing of upper legs.

In operation 330, the apparatus finds a complete pose including a lower arm configuration and a lower leg configuration.

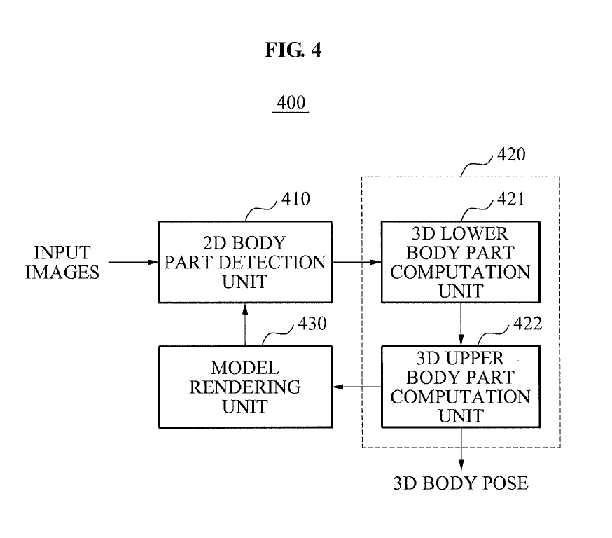

FIG. 4 is a diagram illustrating a configuration of an apparatus capturing motions of a human according to example embodiments.

Referring to FIG. 4, an apparatus 400 capturing motions of a human includes a 2D body part detection unit 410, a 3D body part computation unit 420, and a model-rendering unit 430.

The 2D body part detection unit 410 may be designed to work well for body parts that look like corresponding shapes (e.g. cylinders). Specifically, the 2D body part detection unit 410 may rapidly scan an entire space of possible part locations in input images, and detect candidate 2D body parts as a result of tracking stable motions of arms/legs. As an example, the 2D body part detection unit 410 may use a rectangle-based 2D part detector as a reliable means for tracking fast arm/leg motions in the body part models 100 and 200 of FIGS. 1 and 2. The 2D body part detection unit 410 may be suitable for real-time processing, and may use parallel hardware such as a graphic process unit (GPU).

The 3D body part computation unit 420 includes a 3D lower body part computation unit 421 and a 3D upper body part computation unit 422, and computes a 3D body pose using the detected candidate 2D body parts.

The 3D lower body part computation unit 421 may compute 3D lower body parts using multiple candidate locations for lower arms/hands and lower legs, based on locations of the detected candidate 2D body parts.

The 3D upper body part computation unit 422 may compute 3D lower body parts in accordance with a 3D model-based tracking scheme. Specifically, the 3D upper body part computation unit 422 may compute the 3D body pose using the computed candidate 3D upper body part locations, based on the body part model. As an example, the 3D upper body part computation unit 422 may provide higher accuracy of pose reconstruction since the 3D upper body part computation unit 422 can use more sophisticated body shape models, for example, the triangulated 3D mesh.

The model rendering unit 430 may render the body part model using the 3D body pose outputted from the 3D upper body part computation unit 422. Specifically, the model rendering unit 430 may render the 3D body part model using the 3D body pose outputted from the 3D upper body part computation unit 422, and provide the rendered 3D body part model to the 2D body part detection unit 410.

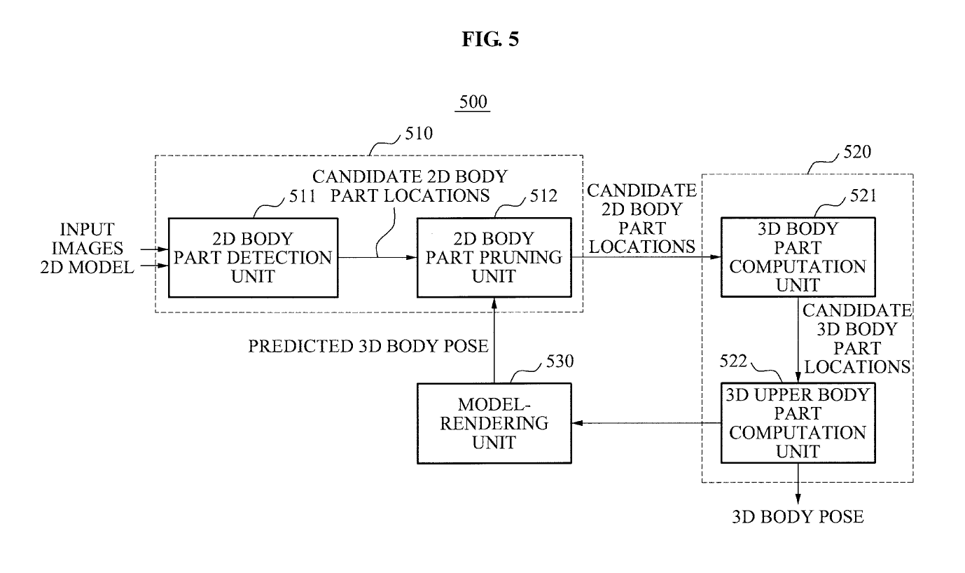

FIG. 5 is a diagram illustrating, in detail, a configuration of an apparatus 500 capturing motions of a human according to example embodiments.

Referring to FIG. 5, the apparatus 500 includes a 2D body part location detection unit 510, a 3D body pose computation unit 520, and a model rendering unit 530.

The 2D body part location detection unit 510 includes a 2D body part detection unit 511 and a 2D body part pruning unit 512. The 2D body part location detection unit 510 may detect candidate 2D body part locations, and detect, from the detected candidate 2D body part locations, the candidate 2D body part locations that are pruned into upper parts and lower parts. The 2D body part detection unit 511 may detect 2D body parts using input images and a 2D model. Specifically, the 2D body part detection unit 511 may detect the 2D body parts by convolving the input images and the 2D model, and output the candidate 2D body part locations. As an example, the 2D body part detection unit 511 may detect the 2D body parts by convolving the input images and the rectangular 2D model, and output the candidate 2D body part locations for the detected 2D body parts. The 2D body part pruning unit 512 may prune the 2D body parts into the upper parts and the lower parts using the candidate 2D body part locations detected from the input images.

The 3D body pose computation unit 520 includes a 3D body part computation unit 521 and a 3D body upper part computation unit 522. The 3D body pose computation unit 520 may compute a 3D body pose using the candidate 2D body part locations. The 3D body part computation unit 521 may receive information about the candidate 2D body part locations, and triangulate 3D body part locations using the information about the candidate 2D body part locations, thereby computing candidate 3D body part locations. The 3D upper body part computation unit 522 may receive the candidate 3D body part locations, and output the 3D body pose by computing 3D upper body parts through pose matching.

The model rendering unit 523 may receive the 3D body pose from the 3D upper body part computation unit 522, and provide, to the 2D body part pruning unit 512, a predicted 3D pose obtained by performing a model rendering unit the 3D body pose.

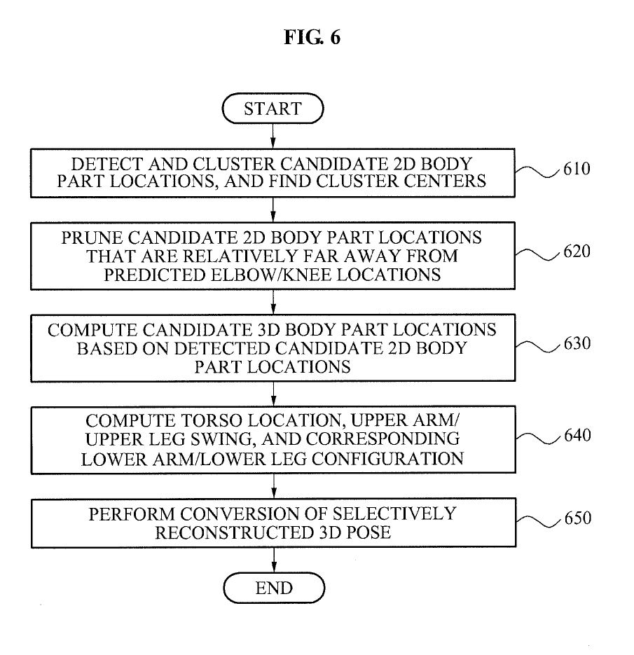

FIG. 6 is a flowchart illustrating, in detail, an example of a method of capturing motions of a human according to example embodiments.

Referring to FIG. 6, in operation 610, an apparatus capturing motions of a human detects and classifies candidate 2D body part locations, and finds cluster centers. As an example, in operation 610, the apparatus detects and classifies the candidate 2D body part locations such as lower arms, lower legs, and the like by convolving input images and a rectangular 2D model, and finds the cluster centers using Mean Shift (a non-parametric clustering technique). The detected 2D body parts may be encoded as a pair of 2D endpoints and a scalar intensity score (measure of contrast of body part and surrounding pixels).

In operation 620, the apparatus prunes the candidate 2D body part locations that are relatively far away, i.e., a predetermined specified distance, from predicted elbow/knee locations.

In operation 630, the apparatus may compute the candidate 3D body part locations based on the detected candidate 2D body part locations. Specifically, in operation 630, the apparatus may output the candidate 3D body part locations such as lower arms/legs and the like by computing a 3D body part intensity score based on the detected candidate 2D body part locations. The 3D body part intensity score may be a sum of 2D body part intensities.

In operation 640, the apparatus may compute a torso location, swing of upper arms/legs, and a corresponding lower arm/leg configuration.

In operation 650, the apparatus may perform a conversion of a selectively reconstructed 3D pose.

According to embodiments, tracking is incremental. The tracking is used to search for a pose in a current frame, starting from a hypothesis generated from a pose in a previous frame. Assuming that P(n) denotes a 3D pose in a frame n, a predicted pose denotes a predicted pose in a frame n+1, which is represented as

P(n+1)=P(n)+λ·(P(n)−P(n−1)), [Equation 1]

where λ is a constant such as 0<λ<1 (used to stabilize tracking).

The predicted pose may be used to filter the candidate 2D body part locations. Elbow/knee 3D locations may be projected into all views. The candidate 2D body part locations that are outside a predefined radius from the predicted elbow/knee locations are excluded from further analysis.

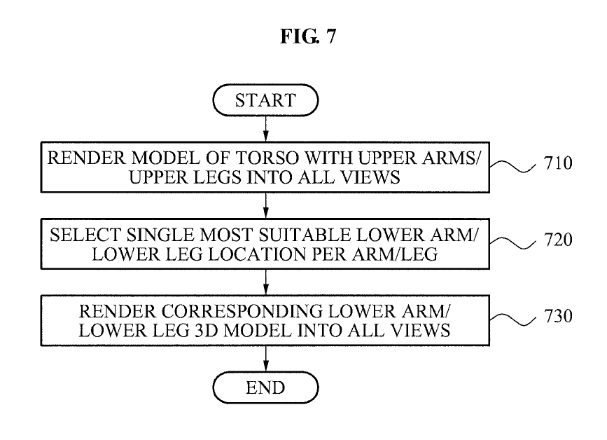

FIG. 7 is a flowchart illustrating an example of a rendering process according to example embodiments.

Referring to FIG. 7, in operation 710, an apparatus capturing motions of a human renders a model of a torso with upper arms/upper legs into all views.

In operation 720, the apparatus selects a single most suitable lower arm/lower leg location per arm/leg.

Also, the apparatus may perform operation 720 by adding up 3D body part connection scores. A proximity score may be computed as a square of a distance in a 3D space from a real connection point to an ideal connection point. A 3D body part candidate intensity score may be computed by a body part detector. A 3D body part re-projection score may be provided from operation 650. A duplicate exclusion score may be a score for excluding duplicated candidates. The apparatus may select a candidate body part with the highest connection score.

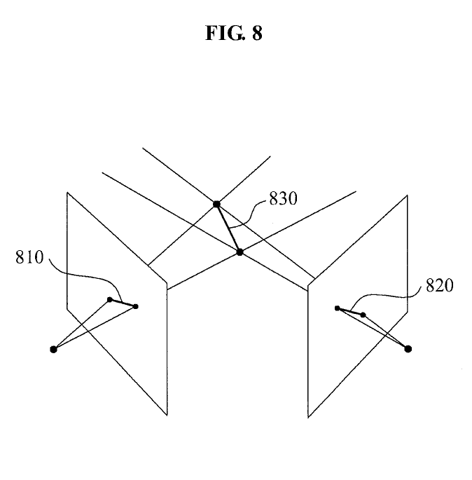

FIG. 8 is a diagram illustrating an example of a triangular measurement method for 3D body parts which may divide three-dimensional (3D) body parts into a triangle according to example embodiments.

Referring to FIG. 8, the triangular measurement method may project line segment projections 810 and 820 in camera views into a 3D line segment projection 830.

For predefined camera pairs, 2D body part locations 810 and 820 may be used to triangulate 3D body part locations.

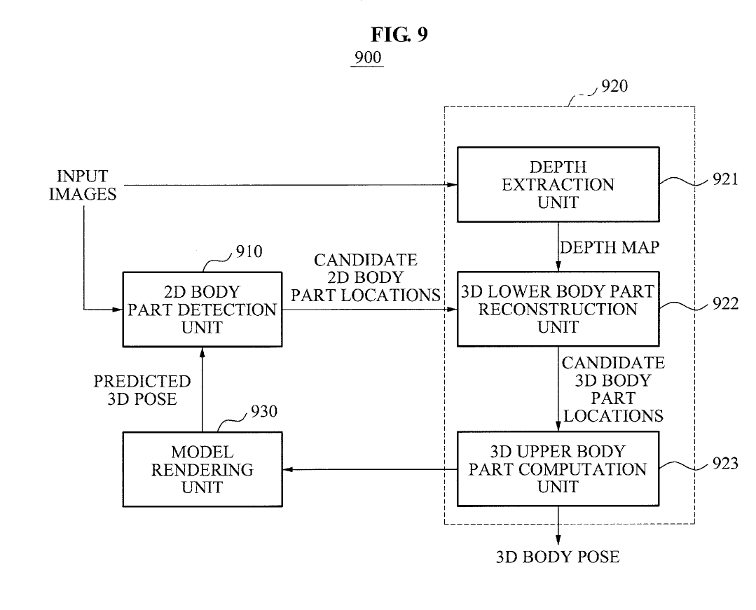

FIG. 9 is a diagram illustrating a configuration of an apparatus 900 of capturing motions of a human according to example embodiments. Referring to FIG. 9, the apparatus includes a 2D body part detection unit 910, a 3D pose generation unit 920, and a model rendering unit 930.

The 2D body part detection unit 910 may detect 2D body parts from input images, and output candidate 2D body part locations.

The 3D pose generation unit 920 includes a depth extraction unit 921, a 3D lower body part reconstruction unit 922, and a 3D upper body part computation unit 923.

The 3D pose generation unit 920 may extract a depth map from the input images, compute candidate 3D body part locations using the extracted depth map and the candidate 2D body part locations, and compute a 3D body pose using the candidate 3D body part locations. The depth extraction unit 921 may extract the depth map from the input images. The 3D lower body reconstruction unit 922 may receive the candidate 2D body part locations from the 2D body part detection unit 910, receive the depth map from the depth extraction unit 921, and reconstruct 3D lower body parts using the candidate 2D body part locations and the depth map to thereby generate the candidate 3D body part locations. The 3D upper body part computation unit 923 may receive the candidate 3D body part locations from the 3D lower body part reconstruction unit 922, compute 3D upper body locations using the candidate 3D body part locations, and output a 3D pose generated by pose-matching the computed 3D upper body part locations.

The model rendering unit 930 may receive the 3D pose from the 3D upper body part computation unit 923, and output a predicted 3D pose obtained by rendering a model for the 3D pose.

The 2D body part detection unit 910 may detect, from the model rendering unit 930, 2D body parts using the predicted 3D pose and the input images to thereby output the candidate 2D body part locations.

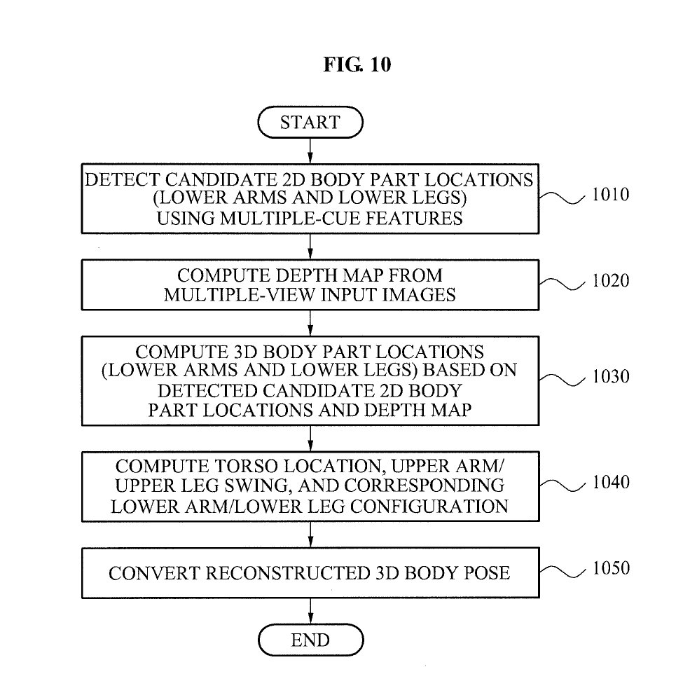

FIG. 10 is a flowchart illustrating a method of capturing motions of a human according to example embodiments.

Referring to FIG. 10, in operation 1010, an apparatus capturing motions of a human according to example embodiments may detect candidate 2D body part locations (e.g. lower arms and lower legs) using multiple-cue features.

In operation 1020, the apparatus may compute a depth map from multi-view input images.

In operation 1030, the apparatus may compute 3D body part locations (e.g. lower arms and lower legs) based on the detected candidate 2D body part locations and the depth map.

In operation 1040, the apparatus may compute a torso location, swing of upper arms/upper legs, and a lower arm/lower leg configuration.

In operation 1050, the apparatus may perform a conversion of a reconstructed 3D pose as an option.

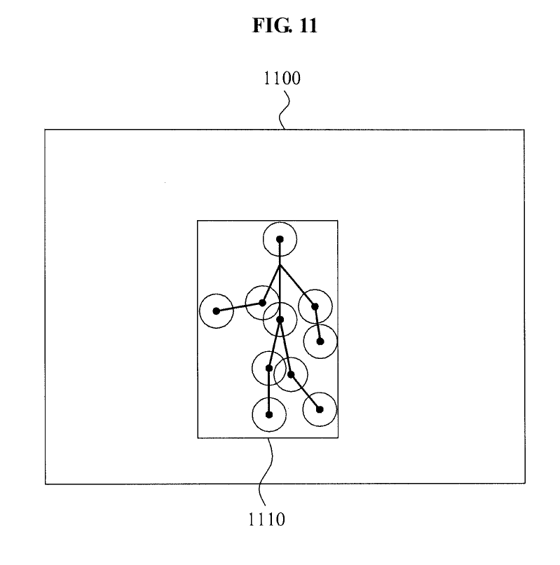

FIG. 11 is a diagram illustrating a region of interest (ROI) for input images according to example embodiments.

Referring to FIG. 11, an apparatus capturing motions of a human according to example embodiments may reduce an amount of computation to thereby improve a processing speed when detecting 2D body parts for a region of interest 1110 (ROI) of an input image 1100 rather than detecting the 2D body parts from the entire input image 1100.

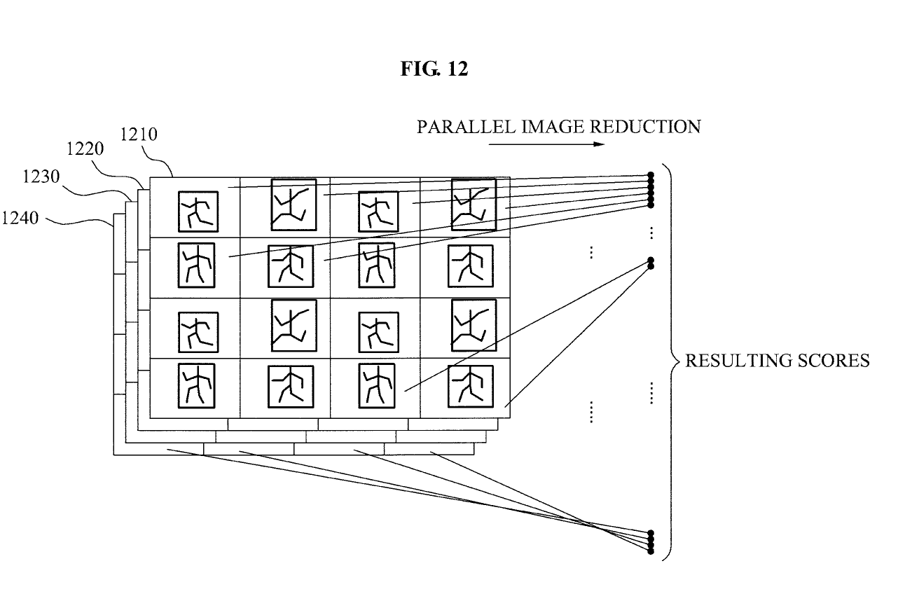

FIG. 12 is a diagram illustrating an example of a parallel image processing according to example embodiments.

Referring to FIG. 12, when an apparatus capturing motions of a human includes a graphic process unit (GPU), a gray image with respect to an ROI of input images may be divided using a red channel 1210, a green channel 1220, a blue channel 130, and an alpha channel 1240, and parallel processing is performed on the divided gray image, thereby reducing an amount of processed images and improving a processing speed.

A further optimization of image reduction may be possible by exploiting a vector architecture of GPUs. Functional units of the GPUs, that is, texture samplers, arithmetic units, and ROI may be designed to process four component values.

Since pixel_match_diff(x, y) is a scalar value, it is possible to store and process 4 pixel_match_diff(x, y) values in separate color planes of render surface for 4 different evaluations of cost function.

As described above, according to example embodiments, there is provided a method and system that may find a 3D skeletal pose, for example, a multidimensional vector describing a simplified human skeleton configuration, for each frame of input video sequence.

Also, according to example embodiments, there is provided a method and system that may track motions of a 3D subject to improve accuracy and speed.

The above described methods may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments have been shown and described, it should be appreciated by those skilled in the art that changes may be made in these exemplary embodiments without departing from the principles and spirit of the disclosure, the scope of which is defined in the claims and their equivalents.

What is claimed is:

1. An apparatus capturing motions of a human, the apparatus comprising:
a two-dimensional (2D) body part detection unit to detect, from input images, candidate 2D body part locations of candidate 2D body parts;
a three-dimensional (3D) lower body part computation unit to compute 3D lower body parts using the detected candidate 2D body part locations;
a 3D upper body computation unit to compute 3D upper body parts based on a body model; and
a model rendering unit to render the model in accordance with a result of the computed 3D upper body parts,
wherein, a model-rendered result is provided to the 2D body part detection unit, the 3D lower body parts are parts where a movement range is greater than a reference amount, from among the candidate 2D body parts, and the 3D upper body parts are parts where the movement range is less than the reference amount, from among the candidate 2D body parts.

2. The apparatus of claim 1, wherein the 2D body part detection unit comprises a 2D body part pruning unit to prune the candidate 2D body part locations that are a specified distance from predicted elbow/knee locations, from among the detected candidate 2D body part locations.

3. The apparatus of claim 2, wherein the 3D lower body part computation unit computes candidate 3D upper body part locations using upper body part locations of the pruned candidate 2D body part locations, the 3D upper body part computation unit computes a 3D body pose using the computed candidate 3D upper body part locations based on the model, and the model rendering unit provides a predicted 3D body pose to the 2D body part pruning unit, the predicted 3D body pose obtained by rendering the body model using the computed 3D body pose.

4. The apparatus of claim 1, further comprising:
a depth extraction unit to extract a depth map from the input images,
wherein the 3D lower body part computation unit computes candidate 3D lower body part locations using upper body part locations of the pruned candidate 2D body part locations and the depth map.

5. The apparatus of claim 1, wherein the 2D body part detection unit detects, from the input images, the candidate 2D body part locations for a Region of Interest (ROI), and includes a graphic processing unit to divide the ROI of the input images into a plurality of channels to perform parallel image processing on the divided ROI.

6. A method of capturing motions of a human, the method comprising:
detecting, by processor, candidate 2D body part locations of candidate 2D body parts from input images;
computing, by the processor, 3D lower body parts using the detected candidate 2D body part locations;
computing, by the processor, 3D upper body parts based on a body model; and
rendering, by the processor, the body model in accordance with a result of the computed 3D upper body parts,
wherein a model-rendered result is provided to the detecting, the 3D lower body parts are parts where a movement range is greater than a reference amount, from among the candidate 2D body parts, and the 3D upper body parts are parts where the movement range is less than the reference amount, from among the candidate 2D body parts.

7. The method of claim 6, wherein the detecting of the candidate 2D body part includes pruning the candidate 2D body part locations that are a specified distance from predicted elbow/knee locations, from among the detected candidate 2D body part locations.

8. The method of claim 7, wherein:
the computing of the 3D lower body parts includes computing candidate 3D lower body part locations using the pruned candidate 2D body part locations,
the computing of the 3D upper body parts includes computing a 3D body pose using the computed candidate 3D upper body part locations based on the body model, and
the rendering of the body model provides a predicted 3D body pose to the processor, the predicted 3D body pose obtained by rendering the body model using the computed 3D body pose.

9. The method of claim 6, further comprising:
extracting a depth map from the input images,
wherein the computing of the 3D lower body parts includes computing candidate 3D lower body part locations using the pruned candidate 2D body part locations and the depth map.

10. The method of claim 6, wherein the detecting of the 2D body part locations detects, from the input images, the candidate 2D body part locations for an ROI, and includes performing a parallel image processing on the ROI of the input images by dividing the ROI into a plurality of channels.

11. At least one non-transitory computer readable medium comprising computer readable instructions that control at least one processor to implement a method, comprising:
detecting candidate 2D body part locations of candidate 2D body parts from input images;
computing 3D lower body parts using the detected candidate 2D body part locations;
computing 3D upper body parts based on a body model; and
rendering the body model in accordance with a result of the computed 3D upper body parts,
wherein a model-rendered result is provided to the detecting, the 3D lower body parts are parts where a movement range is greater than a reference amount, from among the candidate 2D body parts, and the 3D upper body parts are parts where the movement range is less than the reference amount, from among the candidate 2D body parts.

12. The at least one non-transitory computer readable medium of claim 11, wherein the detecting of the candidate 2D body part includes pruning the candidate 2D body part locations that are a specified distance from predicted elbow/knee locations, from among the detected candidate 2D body part locations.

13. The at least one non-transitory computer readable medium of claim 12, wherein
the computing of the 3D lower body parts includes computing candidate 3D lower body part locations using the pruned candidate 2D body part locations,
the computing of the 3D upper body parts includes computing a 3D body pose using the computed candidate 3D upper body part locations based on the body model, and
the rendering of the body model provides a predicted 3D body pose, the predicted 3D body pose obtained by rendering the body model using the computed 3D body pose.

14. The at least one non-transitory computer readable medium of claim 11, wherein the method further comprises:
extracting a depth map from the input images,
wherein the computing of the 3D lower body parts includes computing candidate 3D lower body part locations using the pruned candidate 2D body part locations and the depth map.

15. The at least one non-transitory computer readable medium of claim 11, wherein the detecting of the 2D body part locations detects, from the input images, the candidate 2D body part locations for an ROI, and includes performing a parallel image processing on the ROI of the input images by dividing the ROI into a plurality of channels.
